(19) United States
(12) Patent Application Publication
(10) Pub. No.: US 2016/0335565 A1
(43) Pub. Date: Nov. 17, 2016

(54) IN-EVENT SEAT EXCHANGE

(71) Applicant: STUBJUMPER, LLC, Roselle, IL (US)

(72) Inventors: Brent L. Charriere, Hudson, OH (US); Dennis P. Foster, JR., Roselle, IL (US)

(73) Assignee: STUBJUMPER, LLC, Roselle, IL (US)

(21) Appl. No.: 15/218,224

(22) Filed: Jul. 25, 2016

Related U.S. Application Data
(63) Continuation-in-part of application No. 13/009,095, filed on Jan. 19, 2011.

(51) Int. Cl. G06Q 10/02

(52) U.S. Cl. CPC G06Q 10/02

(57) ABSTRACT

A method for a (peer to peer) in-event ticket exchange that occurs inside the ticked event venue after the original ticket holders have gained entry to the venue is provided. The method comprises reselling or exchanging event tickets on a tertiary market within the event venue after the tickets are used to gain admission to the event but while the tickets still retain a valid right to a seating/viewing location where an electronically accessible database connects first ticket owner to second ticket owner at the event who wish to upgrade their seating/viewing location.

### REFERENCE TO RELATED APPLICATION

This application is a Continuation in Part of application Ser. No. 13/009,095 filed Jan. 19, 2011, which claims priority to and the benefit of U.S. Provisional Application Ser. No. 61/296,458 which was filed Jan. 19, 2010, entitled IN-EVENT SEAT EXCHANGE, the entirety of both are hereby incorporated by reference as if fully set forth herein.

### FIELD OF THE INVENTION

The present invention relates generally to an on-line method for exchanging tickets to an event, and more specifically to a method for a PEER-TO-PEER in-event ticket exchange that may occur during a ticketed event or as soon as the event begins to accept admissions (typically two hours before the start time). During this specified window ticketholders will have the opportunity to exchange/swap their tickets with other ticketholders while in the venue.

### BACKGROUND OF THE INVENTION

There are many ways to obtain tickets for reserved seats at events such as spectator sports games, theatre, opera, orchestra, and the like, all of which may be referred to herein as reserved seat events, or simply “events.” The common aspect of these events is that a person in attendance generally requires a ticket to gain admission to the event venue and, furthermore, the ticket designates a specific event-viewing location (typically a numbered seat) that is reserved for the person bearing the ticket. Generally, tickets that reserve better seats or viewing locations for observing the event are sold at a higher price than less desirable seats/locations within the venue. Examples comprise: orchestra fifth row vs. balcony, box seats vs. upper deck, and reserved seats vs. general admission or standing room only.

Since they confer the right of entry, event tickets must be obtained outside of the event venue so that the ticket bearer may use the ticket to gain admission to the event. Tickets are traditionally obtained by purchase from the event box office or by prepaid subscription which includes internet purchase from the event sponsor or designated ticketing agents such as Ticketmaster® and the like, in addition to informal (if not illegal) brokers or first ticket owner such as scalpers. Sometimes a ticket holder will stand outside of a venue in an attempt to resell an unwanted ticket, but this is an informal and uncomfortable process that can be illegal in many areas of the country. Alternatively, ticket scalpers/brokers will facilitate the process by both buying and exchanging tickets outside of a venue. Sometimes a ticket holder may wish to “upgrade” their ticket by selling it to the scalper and then purchasing a different ticket for a more desirable reserved seating location. The scalper takes ownership of the ticket between buying it and selling it, and makes up for the inherent risk of owning unsold tickets by bargaining for the most advantageous price spread by buying as low as possible and then selling as high as possible. Therefore, the scalper is thus incentivized to provide the worst possible service to his clients.

More recently, ticket exchange services such as StubHub® and Flashseats® offer a legal option for the owner of an event ticket to resell the ticket to someone else. These services are typically used by a season ticket holder or any ticket holder who is unable to attend a particular event and would like to recoup at least a portion of the ticket face value. These exchange services act only as an intermediary in a no-risk transaction between a first ticket owner and a second ticket owner, enabling a secure, simultaneous transfer of payment and ticket ownership. The service subtracts a fee from the payment transfer in an agreed upon manner, but, unlike a broker, the purchaser may never takes physical possession of the ticket itself. If done over the internet, the purchaser must have a means for printing or otherwise obtaining the physical ticket, as an actual ticket is generally necessary to show as proof that the holder is entitled to gain entry to the event and to sit in the seat that is reserved by the ticket.

Prior art U.S. Pat. No. 6,496,809 to Nakfoor discloses a system and method for exchanging event tickets electronically in a secondary market where first ticket owner place ask prices and second ticket owner place bid prices. The database is used to receive and compare an asking price for the resale of a ticket from a potential first ticket owner and then compare that information to a bid price proposed by a potential second ticket owner. However, this invention limits itself to problems associated only with the exchange of paperless tickets prior to the start of an event and focuses on exchanging the right of entry to the venue. There is no provision or teaching designated toward the problem of exchanging a partial ticket right, namely only the right to occupy a certain seating location after entry was gained through other means. Also, the invention is geared to paperless ticket resale and does not address how to exchange a physical ticket or ticket stub.

In another prior art ticket resale method, U.S. Pat. No. 6,107,932 to Walker et al. discloses a system and method for controlling access to an event requiring a ticket where a ticket holder may upgrade the seating location conveyed by accessing a computer database. However, this invention does not provide for a means for exchanging tickets between ticket holders. The focus of the system is a means for physically altering the ticket itself with additional revenue going to the event holder. Another problem that remains unsolved is the method will not work without a ticket including a means to be physically altered to show a new seating location. Therefore, the system will not work with most tickets sold today.

An example of a prior art method of using a central database for exchanging tickets from a first ticket owner to a second ticket owner on a secondary market is taught by U.S. Pat. No. 6,067,532 to Gebb. An original ticket may be redistributed from a first ticket owner who posts ticket information on the automated central database to a second ticket owner. However, the disclosed invention requires distribution of the ticket by the host computer database. This limits the time and the rights conveyed for ticket redistribution to a time before the second ticket owner gains admission to the venue since the ticket necessarily still conveys the right of entry in addition to the seating location. Therefore, a first ticket owner and second ticket owner who have already been admitted to the event would have no means of transferring a physical original paper ticket.

All of these prior art systems and methods for buying, selling, and exchanging tickets are used outside of the physical confines of the event venue itself, and typically occur prior to the start of the event, because the person obtaining the ticket must use it to gain admission to the event. Therefore, a need remains for a system and method of exchanging tickets for an event within the venue after the ticket has been used to gain admittance while the tickets still convey valid rights to seating locations within the venue. More specifically, a need remains for a means and method of transferring an event ticket where the right of admission is expired but where the ticket still includes the right to occupy a specific location within the ticketed venue through a tertiary market that allows a first ticket owner to convey a ticket with a partial right to a second ticket owner who has gained admission to the event through other means or within specified time prior to the event such as a two hours prior to the start event.

### SUMMARY OF THE INVENTION

Accordingly, the present invention overcomes the limitations of the prior art by providing a system and method for using an on-line system for exchanging tickets to an event. More particularly, the system and method is for an in-event ticket exchange between a first ticket owner and a second ticket owner that may occur any time after the first ticket owner and the second ticket owner have been admitted to the event venue so that the first ticket owner may obtain some value for the remaining ticket rights and the second ticket owner may change or improve his event viewing location. This exchange can also be utilized two hours before an event, when other ticket sites have already ended the ticket exchange process for a particular event.

Consequently, the following presents a simplified summary of the invention in order to provide a basic understanding of some aspects of the invention. This summary is not an extensive overview of the invention. It is intended to neither identify key or critical elements of the invention nor delineate the scope of the invention. Its purpose is to present some concepts of the invention in a simplified form as a prelude to the more detailed description that is presented later.

It is an object of the invention to provide a system and/or a method for exchanging or upgrading a ticket for an event either after the event has started and/or after an original ticket holder used the ticket to gain admission to the event. This exchange can also be done prior to the event starting, such as two hours before an event, when other ticket sites have already ended the ticket exchange process for a particular event.

It is a further object of the invention to present a system and/or a method for an event attendee ticket holder to recoup part of or possibly more than an original ticket cost while still being able to attend the event from a less desirable location after the event has started and after the ticket holder was admitted to the event venue.

It is an object of the invention to provide a system and/or a method for recovering part of or possibly more than an event ticket price for an admitted ticket holder who needs or desires to leave the event after the ticket holder was admitted or after the event has started.

It is yet a further object of the invention to present a system and/or a method of exchanging tickets after admission to the ticked event while a first ticket owner and a second ticket owner are inside the physical confines of a venue. This exchange can also be done prior to the event starting, such as two hours before an event, when other ticket sites have already ended the ticket exchange process for a particular event.

It is another object of the invention to provide a system and/or a method of upgrading an event attendee's seat location after an event has started or after the attendee has been admitted to the event venue.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 illustrates a top view of an event inside an event venue wherein ticket first ticket owner and ticket second ticket owner can exchange various tickets through utilizing an electronic system and a computer database.

FIG. 2 is a functional block diagram illustrating at least one aspect of the in-event seat exchange invention.

FIG. 3 is yet another functional block diagram illustrating yet another at least another aspect of the in-event seat exchange invention.

FIG. 4 illustrates a functional block diagram of yet another aspect or aspects of the in-event seat exchange invention.

FIG. 5 illustrates a functional block diagram of yet another aspect or aspects of the in-event seat exchange invention.

### DETAILED DESCRIPTION OF THE INVENTION

The present invention is directed generally towards a system and a method of exchanging event tickets through an on-line intermediary after the ticket has been used to gain admission to an event. More particularly, the system and/or method provide for the resale or exchange of tickets within the ticketed venue after the ticket has been used to gain admission to the event while the tickets still confer a right to occupy a specific seat or viewing location within the venue. Accordingly, the present invention will now be described with reference to the drawings, wherein like reference numerals are used to refer to like elements throughout. It should be understood that the description of these various aspects are merely illustrative and that they should not be taken in a limiting sense. In the following description, for purposes of explanation, numerous specific details are set forth in order to provide a thorough understanding of the present invention. It will be evident to one skilled in the art, however, that the present invention may be practiced without these specific details.

Many events limit access to the venue or physical location where the event is held by requiring a ticket for entry to the venue. Professional sporting events typically sell tickets to the event in advance on a primary market to earn revenue for a team, performer or certain act.

While there are many systems and methods for exchanging or exchanging event tickets prior to the ticket holder gaining admission to the event on a secondary market, there are no options for exchange or resale on a tertiary market once the ticket owner uses the ticket to gain admission to the event. A secondary market for ticket sales is a “second” sale of a ticket where the second sale is not necessarily from the event venue or owner, but where the ticket is sold prior to the start of the event. A web service and a scalper are examples how sales may occur on the secondary market. The tertiary market comprises the sale or exchange of a ticket, a ticket stub, and the like where the right of entry has been used and/or is expired, but where the ticket and/or ticket stub still confers at least an additional right. While the most common additional right is the right to occupy a specific seating location, for example a seat number, other additional rights may comprise a viewing location, a loge, a bleacher location, a standing room only area, a restricted seat or section within the venue, improved food service/options, merchandise, personal services, and concierge services, and the like.

The term ticket refers to a device for conferring a right of admission to an event and for conferring an additional right such as a seating location; for example, a paper ticket, a ticket stub, a bar code, a coded magnetic strip, a token, an electronic device, an RFID tag, and any other means known to those skilled in the art for conferring such rights. An example of the system comprises a first ticket owner using a first ticket for gaining admittance to an event venue, the first ticket owner accessing an electronically accessible database through a plurality of internet accessible networking devices, a request from a second ticket owner requesting to exchange the ticket from the first ticket owner on the electronically accessible server, displaying an available tickets listing, a first ticket price, connectivity of the first ticket owner and the second ticket owner, a ticket exchange, and a payment through a credit authority.

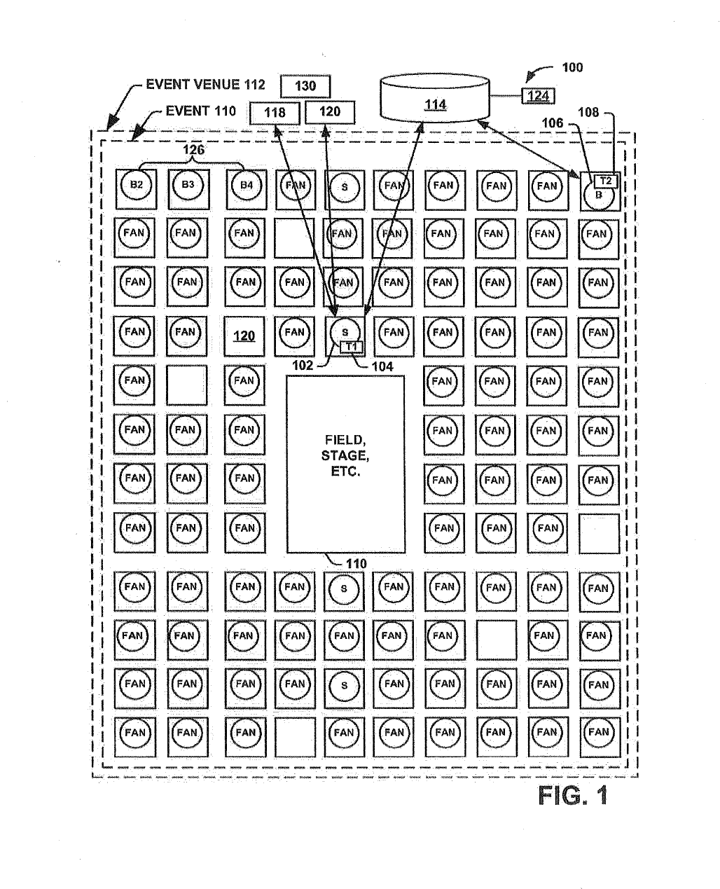

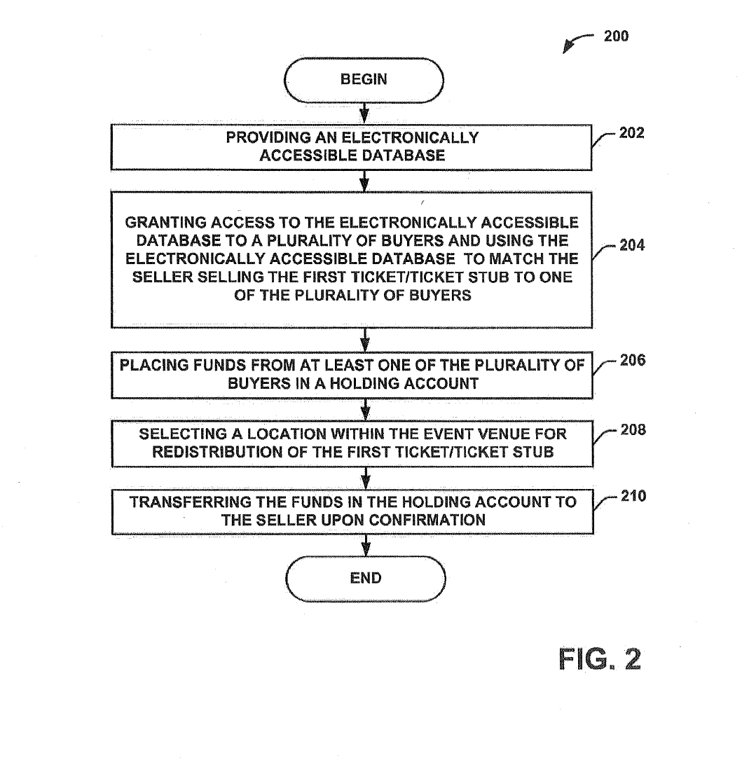

Referring now to the figures, FIGS. 1 and 2 are figures that help in understanding flow chart 200 for generally demonstrating a basic structure 100 and method 200 used for the redistribution/exchange of event tickets/ticket stubs on a tertiary market within an event venue 112 after the tickets have been used to gain admission to the event venue 112 according to the present invention. In a preferred embodiment of the invention, a first ticket owner 102 possessing a first ticket 104 to an event 110 and a second ticket owner 106 possessing a second ticket 108 to the event 110 use the first and second tickets 104, 108 respectively to gain admittance to the event venue 112 where the event 110 is being held. After gaining admission to the event venue 112, the first and second tickets 104, 108 often no longer confer a right of entry to the event venue 112. The first ticket owner 102 comprises anyone who owns or possesses an event ticket such as from an initial or secondary purchase, a season ticket holder, a prize winner, a complimentary ticket holder, a business or other organization that purchased the ticket, and the like. The second ticket owner 106 comprises the same individuals or entities as the first ticket owner, but is further defined as one who requests a ticket conferring an unexpired right, such as a seating location upgrade for example.

While the first ticket owner 102 and the second ticket owner 106 may receive permission to come and go from the event 110 as they choose, many events invalidate the conferred right of entry from a ticket once admission to the event venue 112 is gained. For example, the ticket may be torn in half leaving a ticket stub displaying a seating location, or a barcode scanner may electronically void the ticket for reentry once it is scanned at the event venue admission gate. However, most tickets confer additional property rights which still have considerable value such as the right to occupy a specific seating location within the event 110 after the ticket is used for admission to the event venue 112. For example, other ticket rights comprise a viewing location, a seat number, a reserved seat, a loge, a standing area, and a seat classification comprising preferred, general admission, business class, first class, and the like.

This invention recognizes that a ticket retains additional value after used for admission for the duration of the event 110. However, there is no current convenient method of regaining any value for a ticket once used for admission. Therefore, the method 200 provides a way of recouping some of the face value from a used ticket. The method 200 provides an electronically accessible database 114 at 202. At 204, access to the electronically accessible database 114 is granted to a plurality of second ticket owner 126 so that the electronically accessible database is used to match the first ticket owner 102 of the first ticket/ticket stub 104 to one of the plurality of second ticket owner 126. For example, once the first ticket owner 102 establishes a desire to exchange or transfer the first ticket 104 the first ticket owner 102 makes contact with the electronically accessible database 114 through a database accessible device. Similarly, the second ticket owner 106 may make contact with the electronically accessible database 114 to establish a desire to purchase a seating/viewing location upgrade.

The database accessible device is preferably an internet accessible device comprising a cell phone, a smart phone, a PDA, a wireless internet device, a laptop computer, a wireless notebook/notepad, an internet accessible tablet device, and the like. The database accessible device may be used to connect to the electronically accessible database 114 through systems comprising an email service, a web browser, a short message service application, and the like, or by any other devices of connection to an electronic or internet database. While the invention preferably works through the internet, the inventor recognizes that other systems of connecting to the electronically accessible database 114 may be employed by the first ticket owner 102 and the second ticket owner 106 further comprising wired or cellular telephone service, a computer operator, a touchtone service, automated voice recognition, and other internet accessible devices known by those of skill in the art.

An internet service used to connect the first ticket owner 102 and the second ticket owner 106 to the electronically accessible database 114 comprises any service deployable over the internet, Software as a Service (SaaS), software on demand, Platform as a Service (PaaS), cloud computing, computer network services/platforms, and the like, or by any service known to one skilled in the art. The electronically accessible database 114 further comprises a software database, a service internet database, a virtual internet database, and the like. Additionally, the electronically accessible database 114 may use a reliability rating service to ensure the integrity of transactions.

After the first ticket owner 102 accesses the electronically accessible database 114, the first ticket owner 102 may post or input a first ticket information 118 with a request to sell. The first ticket information 118 initially comprises at least an unexpired valid seating/viewing location 120 within the event venue 112 and an asking price. The preferred embodiment would allow the first ticket owner 102 and the second ticket owner 106 to create a profile 124 on the electronically accessible database 114 comprising a username and a password before allowing a transaction to occur. The profile 124 may additionally comprise a PayPal®. account, credit card information, billing information, personal information, addresses, contact information, an email address, and the like.

The electronically accessible database 114 may be accessed by the plurality of second ticket owner 126 or potential second ticket owner throughout the duration of the event 110 so that the plurality of second ticket owner 126 may browse the available options for a potential upgrade. Once the second ticket owner 106 locates the desired first ticket 104 and creates the profile 124, the electronically accessible database 114 matches the second ticket owner 106 to the first ticket owner 102 and exchanges contact information from the profile 124 of the first ticket owner 102. Next, the second ticket owner 106 contacts the first ticket owner 102 by email, phone, text, messaging service, or the like. If the first ticket owner 102 and the second ticket owner 106 agree to the terms of the transaction, the second ticket owner 106 allows the electronically accessible database 114 to place funds in a holding account sufficient to cover the price of the agreed upon exchange at 206.

If the first ticket owner 102 and the second ticket owner 106 do not agree to the asking price, the electronically accessible database 114 may serve as a Bid/Ask platform with “Bid” responses comprising: “Accept”, “Reject”, and “Counteroffer” options. Then the second ticket owner 106 may make a second ticket owner counteroffer to the first ticket owner 102. The first ticket owner 102 may post a response to accept, reject, or make a first ticket owner counteroffer. The method 200 may end if an agreement between the first ticket owner 102 and the second ticket owner 106 is not reached or may alternatively continue until the terms are acceptable to both the first ticket owner 102 and the second ticket owner 106.

If an agreement is reached, at 208 the first ticket owner 102 and the second ticket owner 106 select, with or without assistance from electronically accessible database 114, an exchange location 130 within the event venue 112 for redistribution of the first ticket 104 from the first ticket owner 102 to the second ticket owner 106. The exchange location 130 may be anywhere within the event venue 112, for example, on the concourse next to the first ticket owner's section, at the first ticket owner's seat, at a gate, at an entrance, near a food vendor, and the like. Similarly, a time for exchange would be chosen, for example at the next time stoppage, intermission, a break, a timeout, and the like, or at any time convenient to the first ticket owner 102 and the second ticket owner 106. Additionally, the event venue 112 could agree to reserve specific exchange locations such as a kiosk, ticket window, and the like.

After the first ticket owner 102 and the second ticket owner 106, or their proxy meet at the exchange location 130, at 210 the second ticket owner 106 may electronically approve the credit transfer from the funds withheld by the holding account after receiving the first ticket 104 from the first ticket owner 102. Simultaneously, the first ticket owner 102 would receive electronic confirmation of the transfer of funds by accessing the profile 124 on the electronically accessible database 114. Alternatively, the first ticket owner 102 may transfer the first ticket 104 to the second ticket owner 106 for cash, merchandise, or other forms of consideration. Additionally, the first ticket owner 102 may exchange the first ticket 104 for the second ticket 108 from the second ticket owner 106 in addition to other consideration.

No matter what the form of consideration, a service fee may be collected by the electronically accessible database 114. The service fee may be withheld from the payment method selected by the first ticket owner 102 comprising a third party paying service, a credit authority, a credit card, a bank account, a deposit account, and the like. Alternatively, the service fee could be charged to the second ticket owner 106 in full or in part, or the service fee could be a flat rate charged to a credit card, PayPal®, phone bill adder, and the like, charged to both the first ticket owner 102 and the second ticket owner 106 when they post the first ticket 104 or create the profile 124. Additionally, separate charges for optional services comprising identifying or connecting the second ticket owner 106 to the first ticket owner 102, negotiating a sale price, making a credit transaction between the first ticket owner 102 and the second ticket owner 106, arranging the exchange location 130, and the like may be charged to the first ticket owner 102 or the second ticket owner 106. Then the method 200 ends.

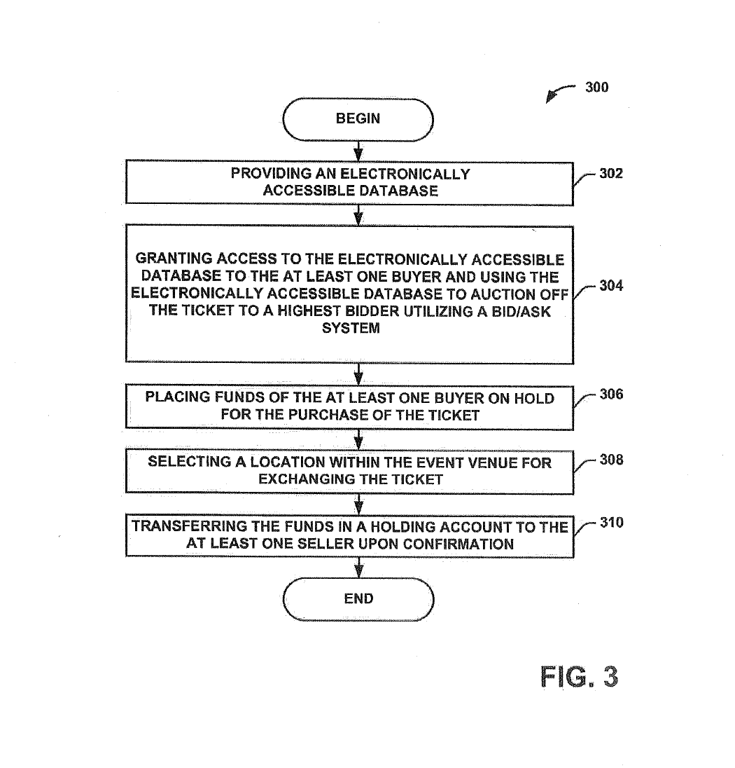

Referring now to FIG. 3, an additional embodiment is described for an in-event seat exchange method 300 between a plurality of first ticket owner and a plurality of second ticket owner 126 after the plurality of first ticket owner and the plurality of second ticket owner 126 have gained admission to an event venue 112. This exchange can also be done prior to the event starting, such as two hours before an event, when other ticket sites have already ended the ticket exchange process for a particular event. The method 300 provides an electronically accessible database at 302. The electronically accessible database 114 is then accessible to the plurality of first ticket owner and the plurality of second ticket owner 126 at 304. The electronically accessible database utilizes an auction format to auction a first ticket 104 to one of the plurality of second ticket owner 126. The auction format comprises a Bid/Ask system further comprising: “Accept”, “Reject”, and “Counteroffer” options, a reverse auction-type format, and an exchange-type format. In addition, the at least one of the plurality of first ticket owner may set a reserve price as a minimum sale price, and may request notification only when the reserve price is met. Also, the at least one of the plurality of first ticket owner may set a reserve price that decreases in relation to the time left in an event 110 as the event 110 progresses. A first ticket information 118 may further comprise an expiration time for the sale of a first ticket 104 for any time period before the event 110 ends or while the first ticket 104 retains a right to confer, such as a post-event meeting or display, for example.

A “winning” second ticket owner 106 may contact a first ticket owner 102 where the terms of the auction are acceptable. Alternatively, the electronically accessible database 114 may be used to contact both the first ticket owner 102 and the second ticket owner 106 to inform them of the conclusion of the auction process.

As in the previous embodiment, the method 300 continues by placing funds from the plurality of second ticket owner 126 in a holding account at 306, an exchange location 130 within the event venue 112 is selected at 308, and the transaction occurs in a similar manner as in the method 200 in FIG. 2 and then ends.

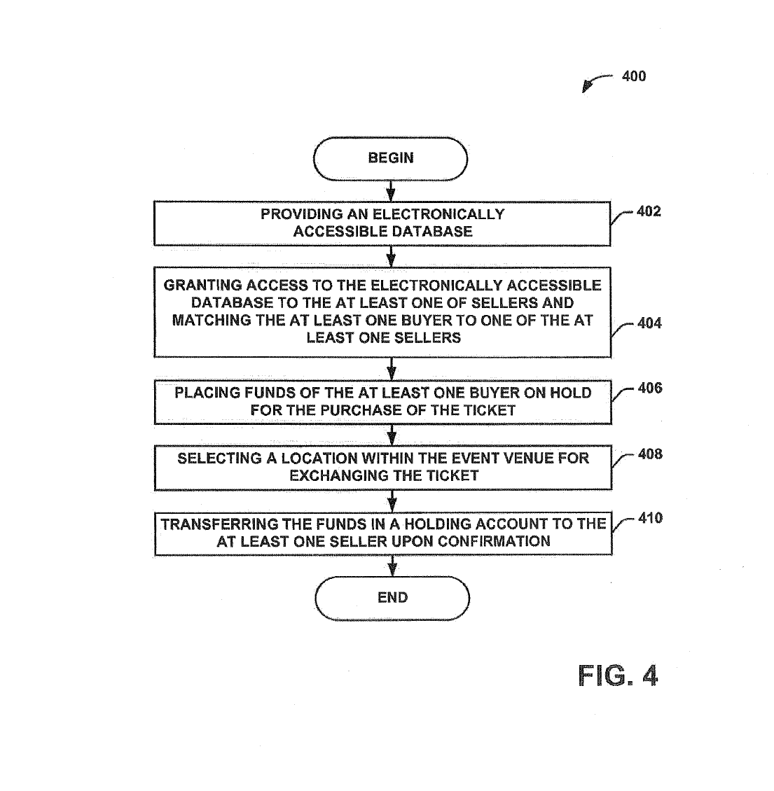

A further embodiment for an in-event seat exchange method 400 between a plurality of first ticket owner and a plurality of second ticket owner 126 after the plurality of first ticket owner and the plurality of second ticket owner 126 have used a ticket to an event 110 to obtain admission to an event venue 112 is described in FIG. 4. At 402, an electronically accessible database 114 is provided as in prior embodiments for at least one of the plurality of first ticket owner to post a first ticket information 118 comprising at least a seating/viewing location 120 and an asking price at 404 Then the electronically accessible database 114 is accessible to the plurality of second ticket owner 126 and matches at least one of the plurality of second ticket owner 126 to the at least one of the first ticket owner. In addition to the capability of the electronically accessible database 114 to receive a posting for a first ticket information 118 for a first ticket 104 from the plurality of first ticket owner, at 404, the plurality of second ticket owner 126 may post a second ticket owner upgrade request on the electronically accessible database 114. The second ticket owner upgrade request may comprise a request to obtain an upgraded seating/viewing location, a reserved seating location, a loge, and the like. Then the electronically accessible database 114 matches the plurality of first ticket owner to the plurality of second ticket owner 126 where the upgrade requests are similar to the first ticket information 118 offered by a first ticket owner 102.

The electronically accessible database 114 permits browsing of a plurality of available first ticket owner tickets and the second ticket owner upgrade requests. Also, the plurality of first ticket owner and the plurality of second ticket owner 126 may sign up for a post from the electronically accessible database 114 of the available first ticket owner's tickets and the second ticket owner upgrade requests respectively. The electronically accessible database 114 may then be used to either accept an offering or permit the plurality of first ticket owner and the plurality of second ticket owner 126 to negotiate acceptable terms for exchange.

As in prior embodiments, the method 400 allows the plurality of first ticket owner and the plurality of second ticket owner 126 to create a profile 124 on the electronically accessible database 114, the profile further comprising: a user name, a password, credit card and/or billing information, and a credit reliability and the plurality of second ticket owner 126 to contact anyone on the electronically accessible database 114 to negotiate a price. Next, the method 400 continues by placing funds from the plurality of second ticket owner 126 in a holding account 406, an exchange location 130 is selected at 408, and the transaction occurs if acceptable to all parties involved at 410. The method 400 optionally comprises an application wherein a bar scanning tool (not shown) is used to confirm the validity of the first ticket 104 and a second ticket 108 if necessary. The bar scanning tool may also be used to limit the number of times a ticket may be resold or exchanged as desired. In any event, the method 400 then ends.

In another aspect of one or more embodiments of the present invention, method and system would verify that both the second ticket owner and first ticket owner have tickets before the exchange occurs. One important aspect in this embodiment is that both the second ticket owner and first ticket owner have to have tickets before the system could be used. Unlike current ticket exchange systems which only require the first ticket owner to have tickets, the present invention is based on both the second ticket owner and first ticket owner having tickets and the first ticket owner for one reason or another needs to dispose of or exchange his/her ticket(s). Many different situations occur that could require a first ticket owner to dispose of tickets, this includes but is not limited to the first ticket owner simply cannot attend and is now able to exchange tickets right before the venue starts, the first ticket owner is at the event but needs to leave, or the first ticket owner cannot accept money for the tickets. The process of verification of both the first ticket owner and the second ticket owner having tickets could take place in various forms, such as, both tickets have been scanned when entering the event venue. In this instance the system server would have access to the venue server and would verify that the tickets have been scanned.

In another embodiment of the present invention, the method and system would only allow the exchange or sale of tickets between the second ticket owner and first ticket owner when the venue opens, when the event starts, or within a certain pre-determined time before the event starts. It is well known in the industry that the sale of tickets by any ticket exchange stops a few hours before the start of the event. The present invention would pick up when these exchanges stop. There is a great need for the exchange of tickets during this time period. For example, the first ticket owner could be stuck in traffic, or be called away in an emergency and cannot in this instance enter the event and have its ticket scanned by the venue. As such, the ability to still sell or exchange the ticket is great, especially with a second ticket owner that wants to upgrade and not necessarily pay for another full price ticket.

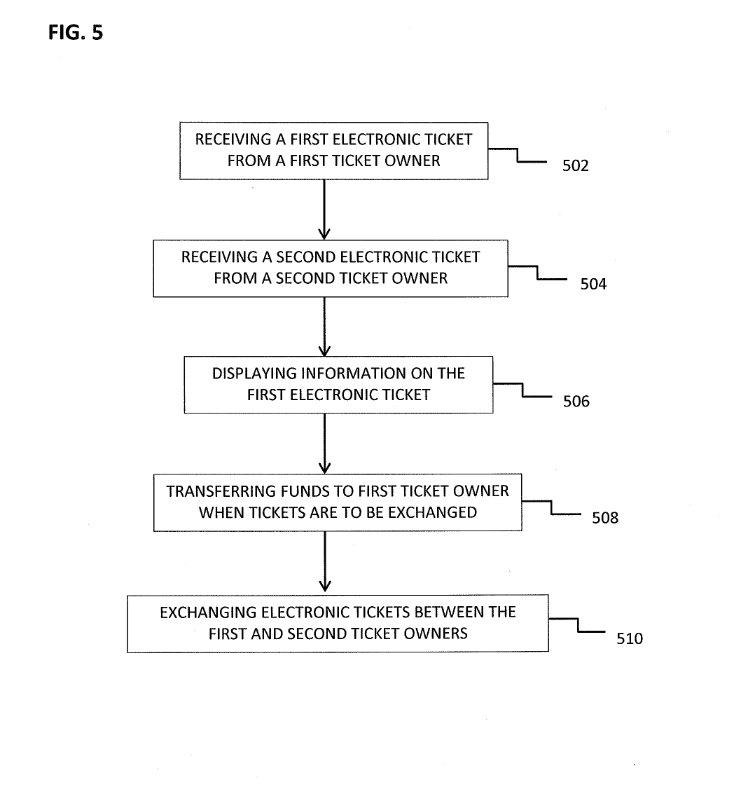

As outlined by one or more of the enclosed embodiments, a computer implemented method for exchanging tickets between two individuals is disclosed by including various steps. As outline in FIG. 5, in a first step 502 an electronically accessible database receives a first electronic ticket from a first ticket owner. In this instance, the first electronic ticket is related to a specific event. In addition, the electronically accessible database may be stored on a client network device with one or more processors. In a second step 504, the electronically accessible database receives a second electronic ticket from a second ticket owner. Similarly, the second electronic ticket is also related to the specific event. In the third step 506, information relating to the first electronic ticket including an exchange price is displayed to an interface with the electronically accessible database. In a fourth step 508, funds are transferred from a second ticket owner account into a first ticket owner account when a purchase of the first electronic ticket by the second ticket owner is completed. In a fifth step 510, the first electronic ticket, now purchased by the second ticket owner, is electronically transferred to the second ticket owner while the second electronic ticket is transferred to the first ticket owner. This method now provides for the exchange of two tickets.

In other aspects of the invention, the step of electronically transferring funds and tickets is restricted to first verifying that a starting time of the specific event has commenced. Verification may occur at any time during the process. For example, it may be more prudent to verify before the first ticket owner has a chance to transfer the first electronic ticket onto the system for possible purchase. This prevents the first ticket owner from wasting time in even trying to upload the ticket or ticket information. As such, the system may only open up the availability for a first ticket owner to upload a ticket or ticket information once the start time of the event has commenced or within a predetermined time prior to the start of an event but after other ticket retailers have closed. To verify a starting time of the specific event, the system may include one or more of the following: (a) receiving an electronic verification from a venue of a commencement of the specific event, (b) electronically comparing a start time of the specific event against an actual time of a request for completion of the purchase, or (c) receiving an electronic verification of an opening of a venue.

In other aspects of the invention the step of electronically comparing a start time of the specific event against an actual time of a request for completion of the purchase includes the actual time being within a predetermined time before the start time of the specific event. In most circumstances, the typical ticket exchange systems close off sales of tickets usually an hour or two before an event commences. The present invention is designed to start allowing ticket holders to exchange and sell when normal ticket exchanges close (as such usually within an hour or two before an event commences). But as outlined herein both the first ticket owner and second ticket owner must have a ticket for the exchange to occur.

In yet other aspects of the embodiments, the steps of electronically transferring funds and tickets are restricted to first verifying that both the first ticket owner and second ticket owner have scanned the first and second electronic tickets at the venue of the specific event. As such, in this instance both the first ticket owner and second ticket owner have actually walked into the event.

In yet other aspects of the embodiments, the first ticket owner may have the option to accept or donate the second electronic ticket. In cases when the first ticket owner cannot use the second electronic ticket, the first ticket owner may choose to donate the ticket back to the system which may first ticket owner or give the ticket away.

In another aspect, the invention provides for a community wherein ticketholders for various events can exchange tickets while the event is in progress, which means when the doors open to allow seating for the event. The community is unique when compared to other exchanges, in that it would be exclusively provided by existing event ticketholders. This allows attendees to upgrade their tickets in exchange for a higher valued seat at a cost to the upgrader, or switcher. It also allows the exchange to a lower valued seat in addition to receiving monetary compensation for the exchange. It further allows the forfeiture of seats by people at the event but who for various reasons are leaving the event.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described components (assemblies, devices, systems, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more other features of the other embodiments as may be desired and advantageous for any given or particular application. Furthermore, to the extent that the terms “including”, “includes”, “having”, “has”, “with”, or variants thereof are used in either the detailed description and the claims, such terms are intended to be inclusive in a similar manner to the term “comprising”.

1. A computer implemented method for exchanging tickets between two individuals, comprising:
receiving on an electronically accessible database, that is stored on a client network device with one or more processors, a first electronic ticket from a first ticket owner, the first electronic ticket being related to a specific event;
receiving on the electronically accessible database a second electronic ticket from a second ticket owner, and wherein the second electronic ticket is also related to the specific event;
displaying from the client network device via an interface with the electronically accessible database, information relating to the first electronic ticket including an exchange price;
electronically transferring funds from a second ticket owner account into a first ticket owner account upon completion of a purchase of the first electronic ticket to the second ticket owner from the first ticket owner; and
electronically transferring the first electronic ticket to the second ticket owner and electronically transferring the second electronic ticket to the first ticket owner upon completion of the purchase.

2. The computer implemented method of claim 1, wherein the steps of electronically transferring funds and tickets are restricted to first verifying a starting time of the specific event has commenced.

3. The computer implemented method of claim 2, wherein verifying a starting time of the specific event includes one or more of the following: (a) receiving an electronic verification from a venue of a commencement of the specific event, (b) electronically comparing a start time of the specific event against an actual time of a request for completion of the purchase, or (c) receiving an electronic verification of an opening of a venue.

4. The computer implemented method of claim 3, wherein the step of electronically comparing a start time of the specific event against an actual time of a request for completion of the purchase includes the actual time being within a predetermined time before the start time of the specific event.

5. The computer implemented method of claim 1, wherein the steps of electronically transferring funds and tickets are restricted to first verifying that both the first ticket owner and second ticket owner have scanned the first and second electronic tickets at the venue of the specific event.

6. The computer implemented method of claim 1, wherein exchange price is fixed.

7. A computer implemented method for exchanging tickets between two individuals, comprising:
receiving on an electronically accessible database, that is stored on a client network device with one or more processors, a first electronic ticket from a first ticket owner, the first electronic ticket being related to a specific event;
receiving on the electronically accessible database a second electronic ticket from a second ticket owner, and wherein the second electronic ticket is also related to the specific event;
displaying from the client network device via an interface with the electronically accessible database, information relating to the first electronic ticket including an exchange price;
electronically transferring funds from a second ticket owner account into a first ticket owner account upon completion of a purchase of the first electronic ticket to the second ticket owner from the first ticket owner;
electronically transferring the first electronic ticket to the second ticket owner; and
sending an electronic request to the first ticket owner to accept or donate the second electronic ticket.

8. The computer implemented method of claim 7, wherein the step of sending an electronic request to the first ticket owner to accept or donate the second electronic ticket includes, upon receiving an acceptance response from the first ticket owner, electronically transferring the second electronic ticket to the first ticket owner.

9. The computer implemented method of claim 7, wherein the step of sending an electronic request to the first ticket owner to accept or donate the second electronic ticket includes, upon receiving a donation response from the first ticket owner, adding the second electronic ticket to the electronically accessible database for resale to a subsequent second ticket owner that has transferred to the electronically accessible database a third electronic ticket from the subsequent second ticket owner, and wherein the third electronic ticket is also related to the specific event.

10. The computer implemented method of claim 7, wherein the steps of electronically transferring funds and tickets are restricted to first verifying a starting time of the specific event has commenced.

11. The computer implemented method of claim 10, wherein verifying a starting time of the specific event includes one or more of the following: (a) receiving an electronic verification from a venue of a commencement of the specific event, (b) electronically comparing a start time of the specific event against an actual time of a request for completion of the purchase, or (c) receiving an electronic verification of an opening of a venue.

12. The computer implemented method of claim 11, wherein the step of electronically comparing a start time of the specific event against an actual time of a request for completion of the purchase includes the actual time being within a predetermined time before the start time of the specific event.

13. The computer implemented method of claim 7, wherein the steps of electronically transferring funds and tickets are restricted to first verifying that both the first ticket owner and second ticket owner have scanned the first and second electronic tickets at the venue of the specific event.

14. The computer implemented method of claim 7, wherein exchange price is fixed.
